(19) United States
(12) Patent Application Publication
(10) Pub. No.: US 2015/0318075 A1
(43) Pub. Date: Nov. 5, 2015

(54) PROFILED CROSS FILLER IN LAN CABLES

(71) Applicant: NEXANS, Paris (FR)

(72) Inventors: Greg Heffner, Ephrata, PA (US); Mike Laudenslager, Landisville, PA (US); Paul Kroushl, Pawtucket, RI (US); Donald Stevens, Lancaster, PA (US)

(21) Appl. No.: 14/267,208

(22) Filed: May 1, 2014

(51) Int. Cl. H01B 3/30; H01B 7/295; H01B 3/44; H01B 11/02

(52) U.S. Cl. CPC H01B 3/301; H01B 11/02; H01B 7/295; H01B 3/443

(57) ABSTRACT

A cross filler for arrangement within a LAN cable has a plurality of twisted pair conductors. The filler has a body and a plurality of radially extending arms, where each of the arms has a plurality of alternating supports and cavities along the surface of the arms. At least one of the radially extending arms is disposed within the LAN cable between at least two of the twisted pairs of the plurality of twisted pairs. The at least one of the radially extending arms is dimensioned such that when the cross filler is positioned with the cable, the at least two of the twisted pairs of the plurality of twisted pairs, on either side of the radially extending arm therebetween, rests on at least one of the supports on the radially extending arm.

### BACKGROUND

1. Field of the Invention

This invention relates to LAN cables. More particularly, the present invention relates to an improved cross filler construction for separating the pairs within a LAN cable.

2. Description of Related Art

LAN (Local Area Network) cables are common communication cables that are typically constructed of eight copper conductor wires in the form of four twisted pairs within a jacket. Owing to increases in signal throughput the electrical and communication performance of such cables is under an ever increasing demand. There are several ways to improve the electrical performance of such cables including varied pair placement, shielding and other techniques.

One such component typically added to LAN cables is a cross filler which is a cross shaped extruded polymer that physically separates the four pairs within the jacket from one another. The purpose of the cross filler is to reduce the internal cross talk between the pairs within the cable by simply keeping a physical distance barrier between the pairs along the length of the cable. Prior art FIG. 1 shows a basic cross filler.

Such cross fillers may be used on theft own or in combination with other LAN cable materials (Le. shields) etc . . . in order to eventually meet the desired electrical characteristics. However, apart from such electrical characteristics there is always the concern that the added components will interfere with meeting the required physical requirements of the cable.

The most basic of the physical requirements/demands is that the cable and its components are made as small and light as possible, and using the least amount of material in order to reduce costs. Also, bending, flexing, fire/smoke safety standards etc . . . also favor a smaller and simpler construction for LAN cables as added materials increase fuel for fire and otherwise make such LAN cables more stiff and less flexible.

Another prior art design is shown in prior art FIGS. 2A-2B, where a cross filler is provided with protrusions from the arms. This is done such that the main arms of the cross filler can be made smaller/thinner with the protrusions holding the pairs apart at a greater desired distance. However, when a twisted pair(s) and a cross filler with such prongs are subjected to helical twisting or cabling, a force is applied towards the arms of the filler. Because of the shape, size and positioning of the prongs, the force of cabling can cause the pairs to push or deform the prongs allowing the pairs to fall into the cavities, This would end up allowing pairs to get closer to one another thus defeating the effectiveness of the filler in generating sufficient physical separation to achieve the desired electrical characteristics.

### OBJECTS AND SUMMARY

As such, there is a need for an improved profiled cross filler that avoids the problems with the prior art. The present invention thus looks to improve on prior art cross fillers by making them lighter and sturdier than prior art versions. In accordance with one embodiment, this is achieved by reducing the material used by adding a profiling to the cross filler arms, and optionally producing the cross filler with an opening in the center. Such a design reduces the amount of material needed to make the cross filler while simultaneously keeping substantially the same overall dimensions and thus the same amount of separation between pairs in the cable. Additionally, the present arrangement maintains the reduced surface area of the cross filler in contact with the pairs and thus reduces any capacitive coupling effects caused by the polymer material of the cross filler.

It is noted that the introduction of the profiles also creates peaks and valleys on the arms of the cross filler. Such peaks and valleys could lead to a reduction in the electrical benefits of the cross filler if the pairs were to press into the valleys as in prior art designs. As such, the arms of the cross filler and the corresponding profiles on such arms in the present arrangement are dimensioned and constructed such that the pairs rest soundly on the projection portions of the profiles and thus do not crush under the cabling process (when the pairs and cross filler are helically twisted together to form the LAN cable core). As such, instead of falling into the grooves or valleys, the pairs remain at the desired distance from one another and thus maintain the desired electrical performance improvements.

To this end, the present arrangement provide for a cross filler for arrangement within a LAN cable having a plurality of twisted pair conductors. The filler has a body and a plurality of radially extending arms, where each of the arms has a plurality of alternating supports and cavities along the surface of the arms. At least one of the radially extending arms is disposed within the LAN cable between at least two of the twisted pairs of the plurality of twisted pairs.

The at least one of the radially extending arms is dimensioned such that when the cross filler is positioned within the cable, the at least two of the twisted pairs of the plurality of twisted pairs, on either side of the radially extending arm therebetween, rests on at least one of the supports on the radially extending arm.

### BRIEF DESCRIPTION OF THE DRAWINGS

The present invention can be best understood through the following description and accompanying drawings, wherein:

FIG. 1 shows a prior art cross filler for LAN cable;

FIGS. 2A-2B show another prior art cross filler for LAN cable;

FIG. 3 shows a profiled LAN cross filler in accordance with one embodiment;

FIG. 4 shows a profiled LAN cross filler in accordance with one embodiment;

FIG. 5 shows a close up of one arm of a profiled LAN cross filler in accordance with one embodiment;

FIG. 6 shows a profiled LAN cross filler with dimensions in accordance with one embodiment;

FIG. 7 is a table showing material usage comparisons between prior LAN cross fillers and LAN cross fillers according to the present arrangement; and

FIG. 8 shows the present profiled LAN cross filler under cabling stress.

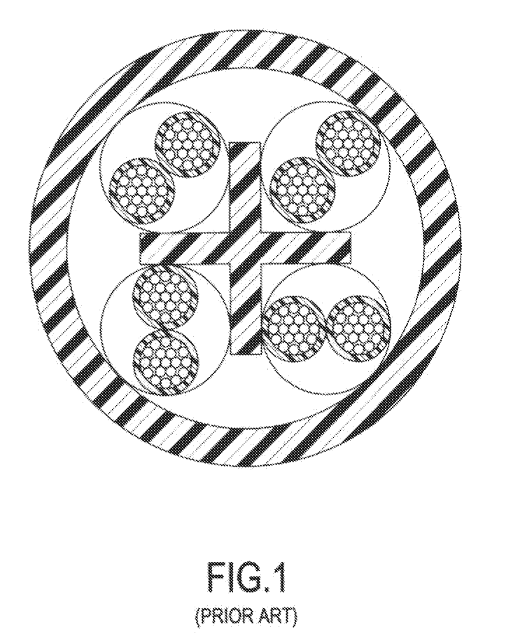

### DETAILED DESCRIPTION

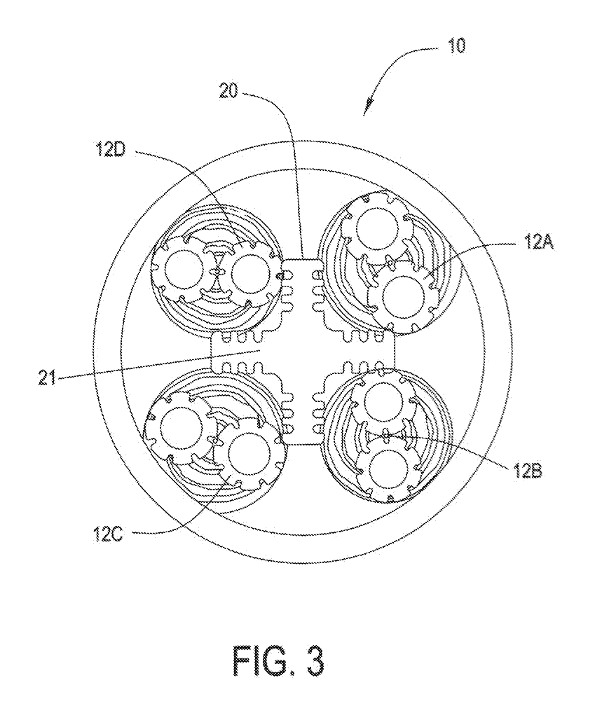

In one embodiment of the present arrangement, as shown in FIG. 3, the present arrangement includes a LAN cable 10 having four twisted pairs 12a-12d and a cross filler 20. Although the present example is shown for a four twisted pair LAN cable, the features of the present cross filler 20 described herein may be equally employed in other cable arrangements requiring internal spacing as well as LAN cables including more or fewer twisted pairs. In one example, cross filler 20 may be constructed by pressure or drawdown extrusion using a shaped die and made from any one of FRPVC (Flame retardant Poly Vinyl Chloride), FRPE (Flame retardant Poly Ethylene), FRPP (Flame retardant Poly Propylene), PE (Poly Ethylene), PP (Poly Propylene), FEP (Fluorinated Ethylene Co-Polymer), PFA (Perfluoroether) and other polymers commonly used in the construction of LAN cables.

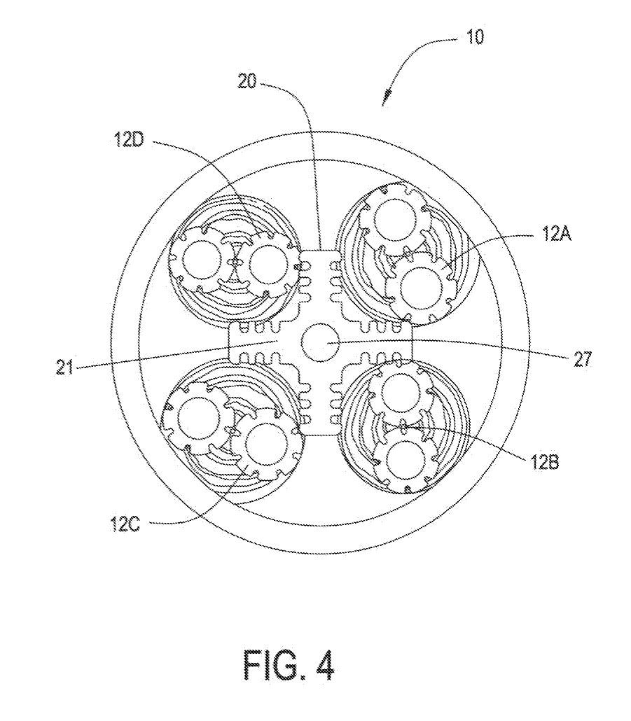

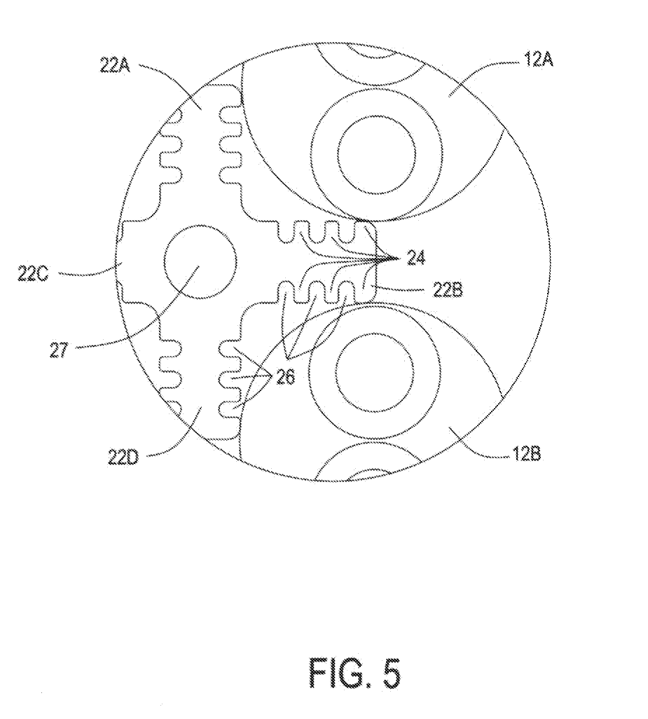

As shown in FIGS. 3-5, cross filler 20 includes a central region 21 and four radically extending arms 22A-22D. Each of arms 22 has a given length from the center of filler 20 as well as a plurality of alternating peaks 24 and valleys 26 along the surface of arms 22 with the end of each arm 22 ending in a peak 24. As shown in FIGS. 4 and 5, central region 21 may have a hollow region 27 or, as shown in FIG. 3, it can be solid.

As shown in FIGS. 3-5 cross filler 20 is configured to be arranged in the center of a LAN cable with four conductor pairs 12A-12D, each separated by one arm 22 of filler 20. It is noted that pairs 12A-12D are twisted pairs each formed from two twisted insulated conductors forming a pair. Because they are formed from twisted wires, pairs 12 have an irregular outer profile at any one location along the length of the pair. However, as the size of each conductor is regular and the conductors are continuously twisted, each pair has a hypothetical outer circumference, shown in FIGS. 3-5 which represents the outer circumference that the conductors of the pair would reach at any point along the length of the pair. In the present arrangement, the length of each arm 22 is such that the end of each arm 22 is substantially at a center point between the two twisted pairs 12 that arm 22 is located between, The result is that the peak 24 located at the end of arms 22 is normally positioned at about the midpoint of the circumference (hypothetical outer circumference) of pairs 12.

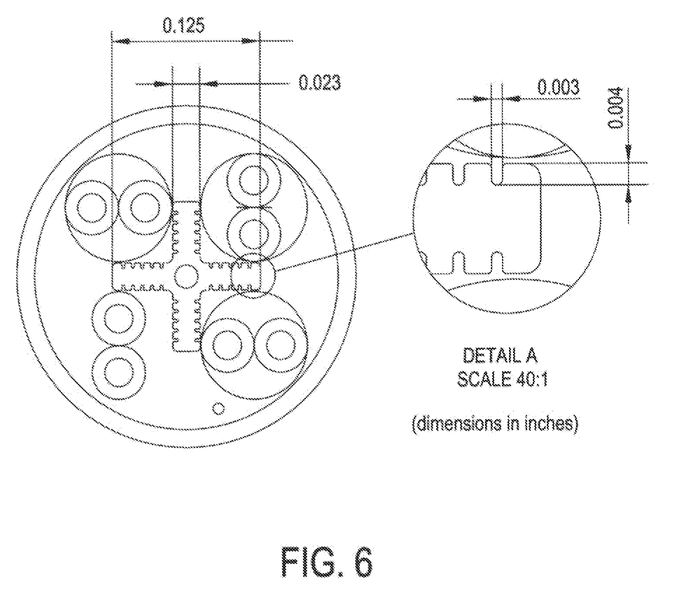

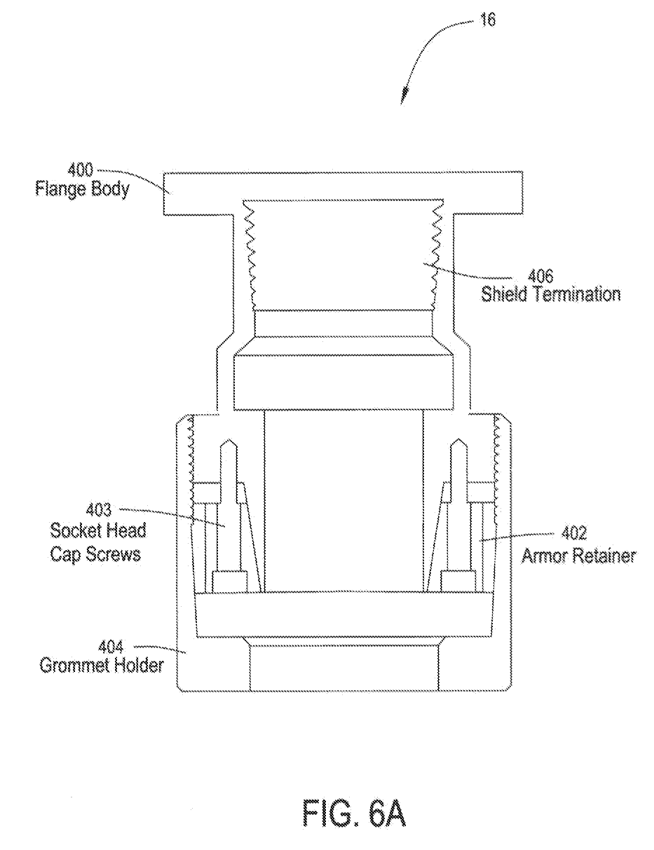

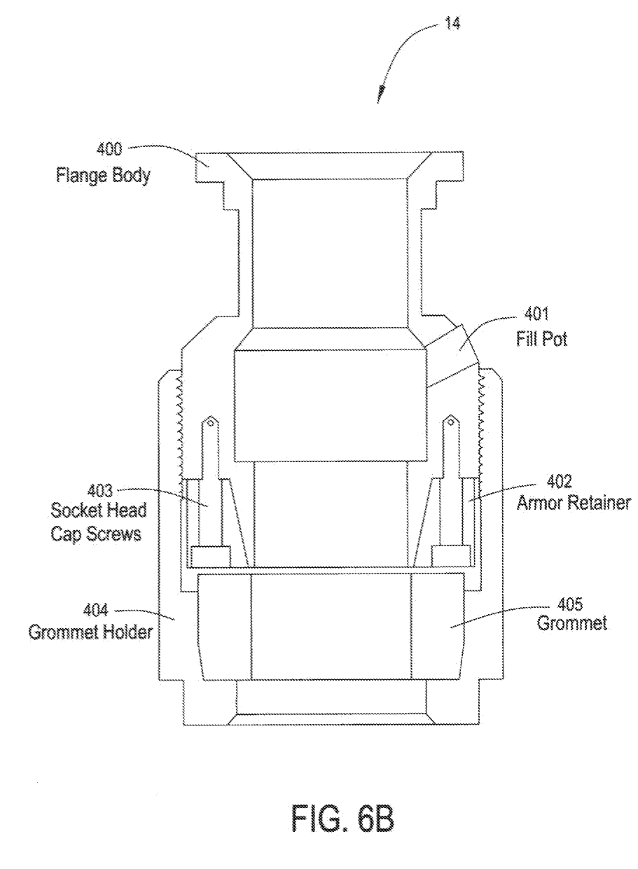

In one embodiment according to a typical LAN cable 10 design having four pairs 12A-12D FIG. 6 shows exemplary dimensions for cross filler 20. The thickness of arms 22 is substantially 0.023″ (thickness is defined between the extents of opposing peaks 24). The diameter of filler 20 may be substantially 0.125″ (from one end of arm 22 to the other end of the opposing arm 22). In other embodiments, arm 22 thickness can range from 0.005″ to 0.050″ and filler 20 diameters can range from 0.050″ to 0.200″ to accommodate different cable designs.

Also shown in FIG. 6, the width of each of valleys 26 (in the direction of length of arm 22) is approximately 0.003.″ An exemplary depth of valleys 26 may be substantially 0.004″. In other embodiments, valleys 26 may preferably range in width from 0.001″ wide to 0.015″ wide and from 0.001″ deep to 0,015″ deep depending on filler 20 design, although the invention is not limited in scope to these dimensions.

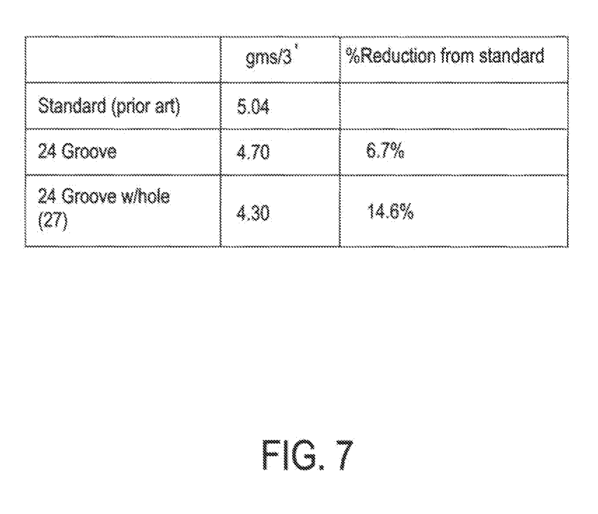

Owing to this design for cross filler 20, a reduction in material can be achieved relative to similarly sized prior art cross fillers of about 5% to 25% depending on the filler design. For example, as shown in the chart on FIG. 7, a standard prior art cross filler is compared against two of the present cross fillers 20 as shown in FIG. 3 (24 valleys) and FIG. 4 (24 valleys w/center hole) using the exemplary dimensions for supports 24 and cavities 26 as set forth above and in FIG. 5. As shown in the chart, by measuring the weight in grams per/3 ft of length, the twenty four groove version of cross filler 20 from FIG. 3 and the twenty four groove whole version of cross filler 20 from FIG. 4 achieved a reduction of 6.7% and 14.6% reduction in weight respectively.

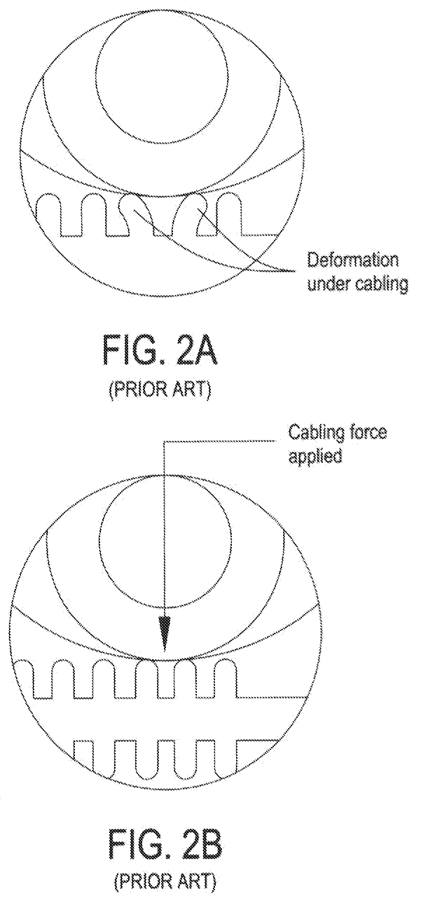

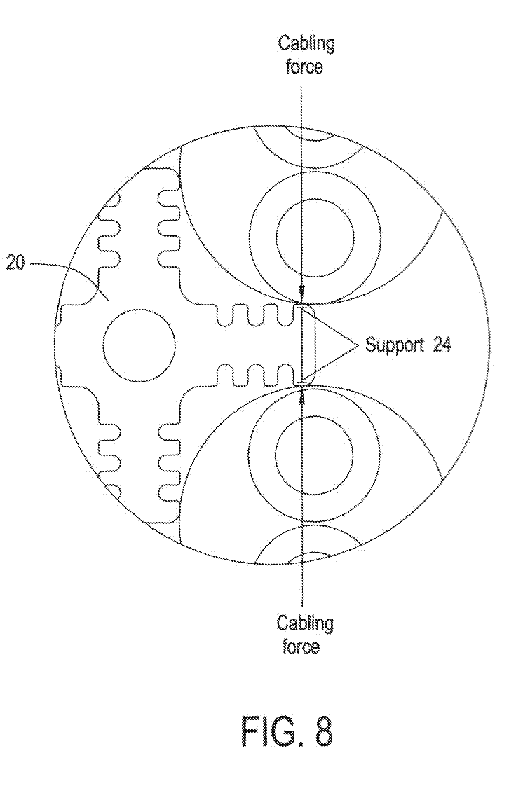

However, in addition to the reduction of material because of the design of cross filler 20, filler 20 simultaneously is able to fully maintain the separation between pairs 12 under the center moving crushing forces inherent in a cabling operation when the components of cable 10 are twisted helically during cable construction. For example FIG. 8 shows a comparison to prior art profiled cross fillers (shown previously in FIGS. 2A-2B) versus the present cross filler 20 (FIG. 8). As discussed above and as shown in FIGS. 2A-2B, when a twisted pair(s) and a cross filler with prongs is subjected to helical twisting or cabling a force is applied towards the arms of the filler. Because of the shape, size and positioning of the prongs, the force of cabling can cause the pairs to push or deform the prongs allowing the pairs to fall into the cavities. This would end up allowing pairs to get closer to one another thus defeating the effectiveness of the filler in generating sufficient physical separation to achieve the desired electrical characteristics.

In comparison to the prior art arrangements of FIGS. 2A-2B, the present arrangement shown in FIG. 8 sets the length of arms 22 of cross filler 20 so that it rests about the midway point of the diameter of pairs 12 (hypothetical diameter of two twisted components of pair 12 taken together) such that when pairs 12 and cross filler 20 are cabled together in the cable manufacturing process, and the center pushing forces are applied by pairs 12 against arms 22, pairs 12 rest on the final support 24 of arms 22 so as to resist such force. This arrangement thus retains pairs 12 at the desired level of physical separation which is the width/thickness of arms 22 while simultaneously maintaining cavities 26 on arms 22 for the reduction of material.

While only certain features of the invention have been illustrated and described herein, many modifications, substitutions, changes or equivalents now occur to those skilled in the art. It is therefore, to be understood that this application is intended to cover all such modifications and changes that fall within the true spirit of the invention.

1. A cross filler for arrangement within a LAN cable having a plurality of twisted pair conductors, said filler comprising:
a body; and
a plurality of radially extending arms,
wherein each of said arms has a plurality of alternating supports and cavities along the surface of said arms,
wherein at least one of said radially extending arms is disposed within said LAN cable between at least two of said twisted pairs of said plurality of twisted pairs, and
wherein said at least one of said radially extending arms is dimensioned such that when said cross filler is positioned with said cable, said at least two of said twisted pairs of said plurality of twisted pairs, on either side of said radially extending arm therebetween, rests on at least one of said supports on said radially extending arm.

2. The cross filler as claimed in claim 1, wherein said cable has four twisted pairs and where said cross filler has four radially extending arms.

3. The cross filler as claimed in claim 2, wherein each of said four twisted pairs are separated by each of said four radially extending arms.

4. The cross filler as claimed in claim 1, wherein said body has a central cavity.

5. The cross filler as claimed in claim 1, wherein said cross filler is made from a polymer selected from the group consisting of FRPVC (Flame retardant Poly Vinyl Chloride), FRPE (Flame retardant Poly Ethylene), FRPP (Flame retardant Poly Propylene), PE (Poly Ethylene), PP (Poly Propylene), FEP (Fluorinated Ethylene Co-Poly e), and PEA (Perfluoroether).

6. The cross filler as claimed in claim 1, wherein said radially extending arms have a thickness in the range of 0.005″ to 0.050″.

7. The cross filler as claimed in claim 6, wherein said radially extending arms have a thickness of substantially 0.023″.

8. The cross filler as claimed in claim 1, wherein said radially extending arms have a diameter of in the range of 0.050″ to 0.200″.

9. The cross filler as claimed in claim 8, wherein said radially extending arms have a diameter of substantially 0.125″.

10. The cross filler as claimed in claim 1, wherein said cavities on said radially extending arms have a width of in the range of 0.001″ to 0.015″.

11. The cross filler as claimed in claim 10, wherein said cavities on said radially extending arms have a width of substantially 0.003″.

12. The cross filler as claimed in claim 1, wherein said cavities on said radially extending arms have a depth of in the range of 0.001″ to 0.015″.

13. The cross filler as claimed in claim 10, wherein said cavities on said radially extending arms have a depth of substantially 0.004.″
